(19) United States
(12) Patent Application Publication
(10) Pub. No.: US 2012/0085750 A1
(43) Pub. Date: Apr. 12, 2012

(54) Covering Device for an Organic Substrate, Substrate with a Covering Device, and Method for Producing a Covering Device

(75) Inventor: Marc Hauer, Zuerich (CH)

(73) Assignee: DYCONEX AG, Bassersdorf (CH)

(21) Appl. No.: 13/218,691

(22) Filed: Aug. 26, 2011

Related U.S. Application Data
(60) Provisional application No. 61/391,086, filed on Oct. 8, 2010.

(51) Int. Cl. B23K 13/01; B23K 1/00; B32B 37/12

(52) U.S. Cl. 219/603; 156/275.7; 219/85.22

(57) ABSTRACT

A covering device for covering an area of an organic substrate, with a connecting zone between a closure cap and the substrate. It is proposed that the connecting zone includes, at least in certain areas, a heating element for heating the connecting zone during the creation of a connection between the closure cap and the substrate. Also provided is an organic substrate with a covering device and a production method for producing a covering device.

### RELATED APPLICATION

This patent application claims the benefit of co-pending U.S. Provisional Patent Application No. 61/391,086, filed on Oct. 8, 2010, which is hereby incorporated by reference in its entirety.

### TECHNICAL FIELD

The invention relates to a covering device for an organic substrate, an organic substrate with a covering device, and a method for producing a covering device according to the preambles of the independent patent claims.

### BACKGROUND

It is known to provide circuits or components on substrates, e.g., printed circuit boards, with a housing. For this, and in particular on organic substrates, a closure cap can be arranged over the circuit or the component and can be fixed on the substrate by means of, for example, ultrasonic welding, soldering, or gluing.

However, with the known methods, damages to the organic substrate can occur, for example, by high energy input during ultrasonic welding. To carry out a soldering method, the closure cap must be metalized or must consist of metal. The solder must be selected such that the soldering temperature is high enough for subsequent processes to which the substrate is still to be subjected, and, on the other hand, low enough to avoid damage to the substrate. Moreover, the solder must be heated by appropriate means, such as, for example, a laser or a soldering iron.

In adhesive processes, the adhesive is to be incorporated in the structure. Generating a hermetically sealed connection is critical with adhesive processes.

The invention is based on the object to provide a covering device which allows a connection as tight as possible between a closure cap and an organic substrate and, at the same time, keeps the thermal load for the substrate and the components to be protected low.

Another object is to propose an organic substrate which allows a connection as tight as possible between the closure cap and the substrate and, at the same time, keeps the thermal load on substrate and components low.

Another object is to specify a method by means of which a connection as tight as possible between the closure cap and the organic substrate and, at the same time, a low thermal load on substrate and components is possible.

### SUMMARY

Said objects are solved according to the invention by the features of the independent patent claims. Advantageous configurations and further advantages of the invention arise from the further dependent claims, the drawings, and the description.

According to a first aspect, the invention is based on a covering device for covering an area of an organic substrate, with a connecting zone between a closure cap and the organic substrate.

It is proposed that the connecting zone comprises, at least in certain areas, a heating element for heating the connecting zone when creating a connection between the closure cap and the substrate.

Creating the connection can be carried out by a systematic local melting of areas provided for the closure cap and the substrate and/or by melting a solder between the closure cap and the substrate, and/or by thermal activation of an adhesive between the closure cap and the substrate. For this, the heating element can be operated, in particular, in a pulsed manner. Thus, a high temperature can be achieved locally in a systematic manner without subjecting areas of the substrate situated further away from the heating element to an unnecessarily high thermal load.

Such a melting is also known as Joule heating. It can advantageously be achieved to locally limit an energy input for forming a connection between the closure cap and the substrate to a significant extent. Advantageously, the heating element can be arranged as close as possible to an interface between the closure cap and the substrate. For this, the heating element can be dedicated to the organic substrate and/or the closure cap. The heating element can be used for the melting of desired areas of the closure cap and/or the substrate. Thus, other connecting methods, such as, for example, soldering, ultrasonic welding, friction welding and/or adhesive bonding can be completely replaced. However, it is also conceivable to combine the heating element with such a method, whereby the energy input into the substrate, for example, for soldering or ultrasonic welding, can be greatly reduced.

Advantageously, with one or more such closure caps, a hermetically sealed assembly based on organic substrates, also known as package, can be generated. The so-called packages serve for protecting certain sensitive components against environmental influences and/or process influences and they are frequently soldered on a circuit board during assembly. Such a package can consist of a base substrate, for example, a printed circuit board, active components, for example, a semiconductor chip, and a closure cap (cover).

Several components, in particular, microelectronic components, such as, for example, high frequency components (HF components) or MEMS (micro-electro-mechanical systems) are very moisture-sensitive. In most cases, an inorganic ceramic substrate is used for such components. Such ceramic substrates do not allow diffusion of water and, at the same time, are highly temperature resistant. In such packages, the closure cap is frequently soldered with a solder having a very high melting point.

However, since the inorganic substrates are fairly expensive, it is, in addition to other advantages, more cost-efficient to use organic substrates. Certain organic substrates, such as, for example, LCP (liquid crystal polymer) have very low gas diffusion and thus are almost equal to the inorganic substrates and thus can also be used for hermetic packages. Due to the fact that, according to the invention, the closure cap can be hermetically sealed with the substrate, it is possible to utilize the advantage of these much more cost-effective materials.

Of course, the covering device and the method for producing the same can also be used on a substrate, in particular, a printed circuit board, to hermetically close certain areas with a closure cap. Depending on the product, the transition between both cases can be absolutely smooth.

Melting the materials by means of a heating element, for example, a heating conductor, does not work for inorganic substrates because the same soften or melt only at a temperature range which is significantly higher than what can be reasonably achieved with a locally arranged heating element, for example, a heating conductor. The same applies also to organic thermosetting plastics, i.e., plastics for which the melting point is higher than the decomposition temperature.

In cases where melting the materials is not possible, the necessary temperature which is generated with the heating element can be used according to the invention for a soldering or gluing process.

Principally, it is also possible that a plurality of areas to be covered can be provided on the substrate, which areas can each be covered in series or advantageously also in parallel with one closure cap, respectively, which is of advantage for a mass production.

The already mentioned packages differ in particular in that they are typically considerably smaller than a substrate in the form of a printed circuit board. It is thus possible in an advantageous manner to simultaneously process or weld many packages on one large production frame and to separate them afterwards into individual packages or covering devices.

Advantageously, the heating element can comprise a conductor that can be heated by direct current flow. By applying an electric voltage via the conductor, an electric current can flow which, through ohmic losses, results in a correspondingly high temperature increase in the conductor and the environment of the conductor. However, it is also conceivable to alternatively heat the heating element through induction and/or coupling of radio frequency (RF) radiation and, in particular, high frequency radiation.

When using suitable current pulses, due to the heat diffusion, the size of the heated areas is well controllable. By introducing additional metal areas, the heat diffusion can be systematically influenced, for example, such that a certain area heats up as homogeneous as possible.

Advantageously, the heating element can surround the area to be covered. A local heating can take place around the entire area to be covered. However, it is also conceivable that a heating element is provided only in certain areas around the area to be covered. Thus, local connections can be established if desired.

The heating element can be covered with a metallization. This is useful, if the closure cap is formed from metal or is metalized, to form a solder connection between the closure cap and the substrate.

According to an advantageous configuration, the heating element of the substrate can be dedicated. Preferably, the heating element can be arranged on the substrate. This useful if, at least in the area close to the connection, the closure cap is formed from a plastic, for example, a thermoplastic. The heating element can also be arranged within the substrate. It is also possible to provide one heating element on the substrate and one heating element within the substrate, which both can interact within an area to be covered or which can be provided for different areas to be covered. This can be advantageously adapted to an actual design of the substrate, such as, for example, a printed circuit board. Since a printed circuit board can have multi-layered circuits, the heating element can be produced in a simple manner within the production process of one or more circuit layers of the printed circuit board. Of course, in the case that more than one area to be covered has to be equipped with a closure cap, it is also possible to produce an array of heating elements in this manner. The heating element can be configured as an electric conductor, the connecting contacts of which are accessible on a surface of the substrate, e.g., the printed circuit board.

Furthermore, the heating element can be dedicated to the closure cap. Here, the heating element can be arranged on the closure cap, in particular, at the edges of the closure cap by means of which the edges of the closure cap are placed onto the substrate, or the heating element can be arranged within the closure cap, or a combination of both possibilities can be used.

The closure cap and/or the substrate can be formed from a plastic, in particular, a thermoplastic. If the thermoplastic involves a material having low water and gas diffusion, in particular, liquid crystal polymer (LCP), the heating element can achieve an almost hermetically sealed connection between the closure cap and the substrate by generating a melt in the area to be covered, which melt subsequently solidifies thereby forming the connection.

The closure cap can be formed from metal. In this case, insulation between the heating element, in particular, in the form of a conductor, and the closure cap is recommended.

According to a further aspect, the invention is based on an organic substrate for a covering device.

It is proposed that a connecting zone between the closure cap and the substrate comprises, at least in certain areas, a heating element for heating the connecting zone when creating a connection between the closure cap and the substrate.

According to an advantageous configuration, the heating element can comprise a conductor which can be heated by direct current flow. Also conceivable is a heating of the heating element by means of induction or irradiation of a high frequency electromagnetic radiation.

The substrate can have more than one area to be covered, which areas can be provided with closure caps in series or in parallel.

According to a further aspect, the invention is based on method for producing a covering device.

The following method steps are proposed:
Providing an organic substrate with an area to be covered with a connecting zone between the substrate and a closure cap, wherein the connecting zone has a heating element, at least in certain areas;
placing the closure cap onto the area to be covered, wherein the edges of the closure cap correspond with a path of the heating element;
activating the heating element for heating the connecting zone;
creating a connection between the closure cap and the substrate in the connecting zone.

Advantageously, with suitable materials (e.g., LCP), an almost hermetically sealed connection can be generated, wherein the energy input takes place only locally in the connecting zone. Activating the heating element can preferably be carried out by applying an electric voltage via a conductor which forms a heating conductor, or also by means of induction and/or coupling of high frequency radiation. Through a high current pulse or a long current flow, the connecting zone, which extends into the substrate and in the closure cap, can melt. During solidification, a (virtually) hermetically sealed connection is formed.

According to an advantageous development, applying a solder for generating a solder connection between the closure cap and the substrate can take place prior to attaching the closure cap. This is advantageous for a metallic or metalized closure cap during soldering of the closure cap to the substrate. Alternatively, prior to attaching the closure cap, an adhesive for creating an adhesive connection between the closure cap and the substrate can be applied, wherein the adhesive is thermally activated.

### DESCRIPTION OF THE DRAWINGS

The invention is explained hereinafter in more detail by way of example and by means of exemplary embodiments illustrated in the drawings. In the figures:

FIGS. 1A and 1B show an exemplary embodiment of a covering device according to the invention with a closure cap made of plastic in a sectional view (FIG. 1A) and a top view (FIG. 1B);

FIGS. 2A-2C show method steps of an advantageous joining method of a covering device according to FIGS. 1A and 1B;

FIGS. 3A and 3B show an exemplary embodiment of a covering device with a closure cap made of metal in a sectional view (FIG. 3A) and a top view (FIG. 3B); and

FIGS. 4A-4D show method steps of an advantageous joining method of a covering device according to FIGS. 3A and 3B.

In the figures, functionally identical or equally acting elements are each designated with the same reference numbers. The figures are schematic illustrations of the invention. They do not represent specific parameters of the invention. Furthermore, the figures represent only typical configurations of the invention and are not intended to limit the invention to the illustrated configurations but, rather, are provided as exemplary embodiments.

### DETAILED DESCRIPTION

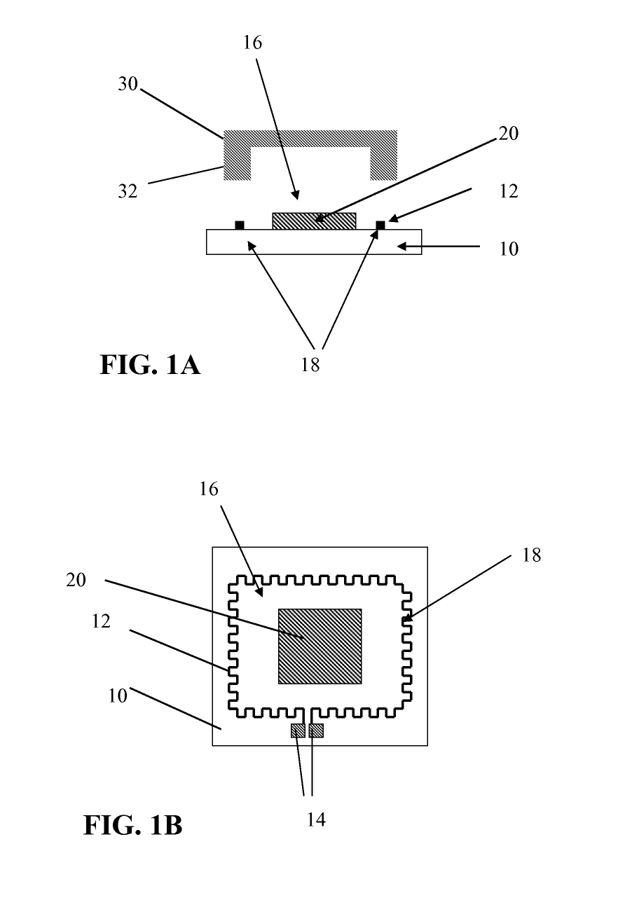

FIGS. 1A and FIG. 1B show in a sectional view (FIG. 1A) with a lifted closure cap 30 and in a top view (FIG. 1B), an exemplary embodiment of a covering device according to the invention with the closure cap 30 made of plastic, preferably a thermoplastic. The covering device is provided for covering an area 16 of a substrate 10 exemplary configured as printed circuit board, and has a connecting zone 18 between the closure cap 30 and the substrate 10 configured, for example, as a printed circuit board. The substrate 10 configured as a printed circuit board is, in particular, a so-called PCB (printed circuit board) with microelectronic circuits.

The connecting zone 18 comprises, at least in certain areas, a heating element 12 for heating the connecting zone 18 during the creation of a connection between the closure cap 30 and the substrate 10 configured as a printed circuit board.

The area 16 to be covered contains, for example, a circuit and/or a component 20 which is to be housed in a preferably hermetical manner with respect to the environment. Of course, a plurality of such areas to be covered can be provided on the organic substrate 10 configured as printed circuit board.

In the shown exemplary embodiment, the heating element 12, which is configured as a conductor which forms a heating conductor, surrounds the area 16 to be covered on the organic substrate 10 configured as printed circuit board. The heating element 12 configured as a conductor can be heated by direct current flow. For this, an electric voltage can be applied to electrical contacts 14 between which the heating element 12 configured as a conductor is arranged. As a heating conductor, the heating element 12 configured as a conductor has a relatively high resistance so that the heating element 12 configured as a conductor and its environment are rapidly heated.

In the present exemplary embodiment, the heating element 12 is arranged on the substrate 10 configured as printed circuit board. It is also conceivable that the heating element is provided alternatively or additionally in the closure cap 30. For this, the closure cap 30 and/or the substrate 10 configured as printed circuit board is formed from a plastic, in particular, a thermoplastic and, in particular, an almost hermetically sealed LCP (liquid crystal polymer) material.

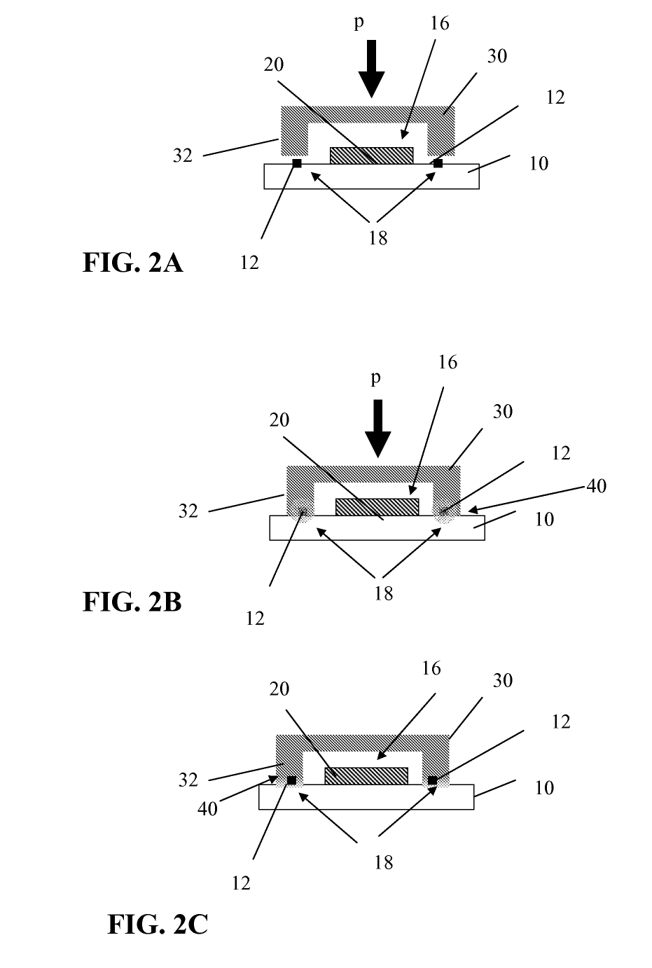

FIGS. 2A-2C show method steps of an advantageous joining method of a covering device according to FIGS. 1A and 1B.

First, the substrate 10 configured as printed circuit board is provided with an area 16 to be covered and with a connecting zone 18 provided between the substrate 10 configured as printed circuit board and the closure cap 30, wherein the connection zone 18 has a heating element 12 at least in certain areas. In the present exemplary embodiment, the heating element 12 is configured as a conductor which surrounds the area 16 to be covered as a heating conductor. The area 16 to be covered has, e.g., a circuit or a component 20 (FIG. 2A).

The closure cap 30 is attached with contact pressure “p” onto the area 16 to be covered, wherein the edges 32 of the closure cap 30 correspond with a path of the heating element 12. The edges 32 rest over the heating element 12 configured as a conductor (FIG. 2B).

Subsequently, an activation of the heating element 12 for heating the connecting zone 18 (FIG. 2C) takes place, wherein the heating element 12 configured as a conductor is supplied with power, and the material of the closure cap 30 and the substrate 10 configured as a printed circuit board melt locally within the connecting zone 18. Thereby, a connection 40 between the closure cap 30 and the substrate 10 configured as printed circuit board is created in the connecting zone 18.

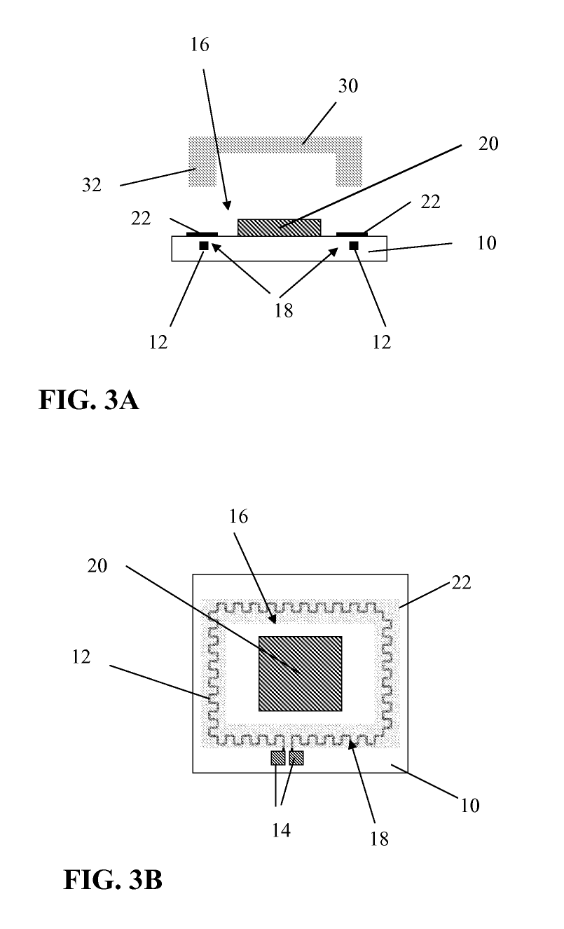

FIGS. 3A and 3B illustrate an exemplary embodiment of a covering device with a closure cap 30 made of metal in a sectional view with lifted closure cap 30 (FIG. 3A), and in a top view (FIG. 3B). The heating element 12 is configured as a conductor and is arranged within the substrate 10 configured as a printed circuit board in order to prevent a short with the closure cap 30. During melting, since the heating element 12 is within the substrate 10 configured as a printed circuit board, thus, no short occurs between the metallic closure cap 30 and the heating element 12.

Over the heating element 12, a metallization 22 is provided on the substrate 10 configured as a printed circuit board. Electrical contact faces 14 for contacting the heating element 12 configured as a conductor can be guided to the surface of the substrate 10 configured as a printed circuit board.

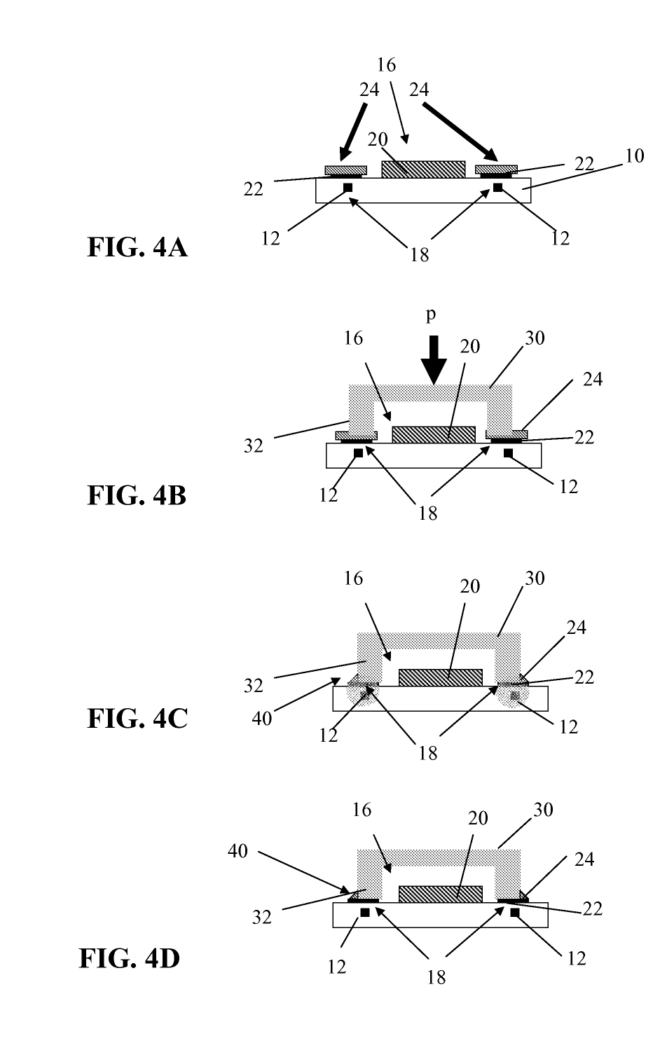

FIGS. 4A-4D show method steps of an advantageous joining method of a covering device according to FIGS. 3A and 3B.

Provided is the substrate 10 configured as a printed circuit board with an area 16 to be covered and with a connecting zone 18 between the substrate 10 configured as a printed circuit board and the closure cap 30, wherein the connecting zone 18 has the heating element 12 at least in certain areas (FIG. 4A). Here, the heating element 12 configured as a conductor is arranged within the substrate 10 configured as a printed circuit board. A metallization 22 is provided over the heating element 12 configured as a conductor, onto which metallization a solder 24 is applied prior to attaching the closure cap 30.

Attaching the closure cap 30 on the area 16 to be covered is carried out under sufficient contact pressure “p”, wherein the edges 32 of the closure cap 30 correspond with a path of the heating element 12 and are arranged over the same (FIG. 4B).

By activating the heating element 12 for heating the connecting zone 18, the solder 24 is melted which wets the edges 32 of the closure cap 30 and the metallization 22 on the substrate 10 configured as a printed circuit board (FIG. 4C) and forms a hermetically sealed connection 40 in the connection zone 18 between the closure cap 30 and the substrate 10 configured as a printed circuit board (FIG. 4D).

It is also conceivable to apply the solder 24 additionally or alternatively onto the contact faces of the edges 32 of the closure cap 30, with which the closure cap 30 is placed onto the substrate 10 configured as a printed circuit board.

Basically, the exemplary embodiment of the FIGS. 3A-3B and 4A-4D can also be used for illustrating the creation of an adhesive connection between the closure cap 30 and the substrate 10 configured as a printed circuit board, wherein the solder 24 is replaced by a thermally activatable adhesive layer.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range.

I/we claim:

1. A covering device for covering an area of an organic substrate, with a connecting zone between a closure cap and the substrate, wherein the connecting zone comprises, at least in certain areas, a heating element for heating the connecting zone during creation of a connection between the closure cap and the substrate.

2. The covering device according to claim 1, wherein the heating element comprises a conductor which can be heated by direct current flow.

3. The covering device according to claim 1, wherein the heating element can be heated by induction and/or RF coupling.

4. The covering device according to claim 1, wherein the heating element surrounds the area to be covered.

5. The covering device according to claim 1, wherein the heating element is covered with a metallization.

6. The covering device according to claim 1, wherein the heating element is dedicated to the substrate.

7. The covering device according to claim 6, wherein the heating element is arranged on the substrate.

8. The covering device according to claim 6, wherein the heating element is arranged within the substrate.

9. The covering device according to claim 1, wherein the heating element is dedicated to the closure cap.

10. The covering device according to claim 1, wherein the closure cap and/or the substrate is formed from a plastic.

11. The covering device according to claim 10, wherein the plastic comprises a thermoplastic.

12. The covering device according to claim 1, wherein the closure cap is formed from a metal.

13. A substrate for a covering device for covering an area of an organic substrate, with a connecting zone between a closure cap and the substrate, wherein the connecting zone comprises, at least in certain areas, a heating element for heating the connecting zone during creation of a connection between the closure cap and the substrate.

14. The substrate for a covering device according to claim 13, wherein the heating element comprises a conductor which can be heated by direct current flow.

15. A method for producing a covering device for covering an area of an organic substrate, with a connecting zone between a closure cap and the substrate, wherein the connecting zone comprises, at least in certain areas, a heating element for heating the connecting zone during creation of a connection between the closure cap and the substrate, the method comprising the following steps:
providing an organic substrate with an area to be covered, with a connecting zone between the substrate and a closure cap, wherein the connecting zone has a heating element, at least in certain areas;
placing the closure cap onto the area to be covered, wherein edges of the closure cap correspond with a path of the heating element;
activating the heating element for heating the connecting zone; and
creating a connection between the closure cap and the substrate in the connecting zone.

16. The method according to claim 15, further comprising the step of applying a solder prior to attaching the closure cap for creating a solder connection between the closure cap and the substrate.

17. The method according to claim 15, further comprising the step of applying an adhesive prior to attaching the closure cap for creating an adhesive connection between the closure cap and the substrate.
